(19) United States
(12) Patent Application Publication
(10) Pub. No.: US 2015/0098124 A1
(43) Pub. Date: Apr. 9, 2015

(54) COMPOSITION AND PROCESS FOR SEALING MICROCELLS

(71) Applicant: E Ink California, LLC, Fremont, CA (US)

(72) Inventors: Yu LI, Fremont, CA (US); Zoran Topalovic, San Jose, CA (US); Ming Wang, Fremont, CA (US); HongMei Zang, Fremont, CA (US); Hui Du, Milpitas, CA (US)

(21) Appl. No.: 14/506,450

(22) Filed: Oct. 3, 2014

Related U.S. Application Data
(60) Provisional application No. 61/887,241, filed on Oct. 4, 2013.

(51) Int. Cl. G02F 1/167; G02F 1/1333; G02F 1/1339

(52) U.S. Cl. CPC G02F 1/167; G02F 1/1339; G02F 1/133377
USPC 359/296

(57) ABSTRACT

The present invention is directed to an improved method for sealing microcells. More specifically, the invention is directed to the formation of covalent bonding between a sealing layer and a microcell structure. A microcell-based display device, formed according to the present invention, has a strong adhesion between the sealing layer and partition walls in the microcell structure which can prevent defects and significantly improve reliability of the device.

This application claims the benefit of U.S. Provisional Application No. 61/887,241, filed Oct. 4, 2013. The contents of the above-identified application is incorporated herein by reference in its entirety.

### BACKGROUND

U.S. Pat. Nos. 6,930,818 and 6,933,098 describe technology for the preparation of cup-like microcells. Briefly, the microcells may be prepared by microembossing or imagewise exposure. In case of microembossing, the microcells are formed on an electrode/substrate layer with a male mold. The male mold may be released during or after the microcell structure is fully or partially hardened.

The microcells may be filled with a display fluid and the filled microcells are then sealed with a sealing layer, which can be accomplished by a one-pass method or a two-pass method. In the one-pass method, a sealing composition is dispersed in the display fluid and the sealing composition is immiscible with the display fluid and preferably has a specific gravity lower than that of the display fluid. The two compositions, i.e., the sealing compositing and the display fluid, are thoroughly mixed and immediately coated onto the formed microcells. The sealing composition subsequently separates from the display fluid and floats on top of the display fluid. In a two-pass method, a display fluid may be filled into the microcells first and a sealing composition is subsequently overcoated onto the filled microcells.

In either case, a sealing layer is formed by hardening the sealing composition in situ (i.e., when in contact with the display fluid). The hardening of the sealing composition may be accomplished by UV or other forms of radiation, such as visible light, IR or electron beam. Alternatively, heat or moisture may also be employed to harden the sealing composition, if a heat or moisture curable sealing composition is used.

The US patents referred to above are incorporated herein by reference in their entirety.

### SUMMARY OF THE INVENTION

The present invention is directed to a display device comprising:
a) a microcell structure with microcells filled with a display fluid; and
b) a sealing layer enclosing the display fluid within each of the microcells,
   wherein there is covalent bonding between the sealing layer and the microcell structure.

In one embodiment, the covalent bonding is formed from crosslinking between functional groups from a composition for forming the sealing layer and a composition for forming the microcell structure, respectively.

In one embodiment, the functional groups from the composition for forming the microcell structure are unreacted after curing of the microcell structure.

In one embodiment, the functional groups from the microcell structure are from a material additionally added to the composition for forming the microcell structure.

In one embodiment, the functional group is hydroxyl group, amino group or carboxyl group.

In one embodiment, the functional groups from the microcell structure are from post treatment of surface of the microcell structure.

In one embodiment, the functional group is COOH, —NH₂ or —OH.

In one embodiment, functional group pairs between the sealing layer and the microcell structure are carboxylic acid group/carboxylic acid group, carboxylic acid group/amino group, carboxylic acid group/hydroxyl group or carboxylic acid group/expoxy group.

In one embodiment, functional group pairs between the sealing layer and the microcell structure are vinyl group/vinyl group or vinyl group/mercapto group.

In one embodiment, the display fluid is an electrophoretic fluid.

### BRIEF DESCRIPTION OF THE DRAWINGS

FIG. 1 illustrates a microcell structure.

FIGS. 2a and 2b are abbreviated drawings to illustrate the present invention.

### DETAILED DESCRIPTION OF THE INVENTION

The present invention is directed to an improved method for sealing microcells. More specifically, the invention is directed to the formation of covalent bonding between a sealing layer and a microcell structure.

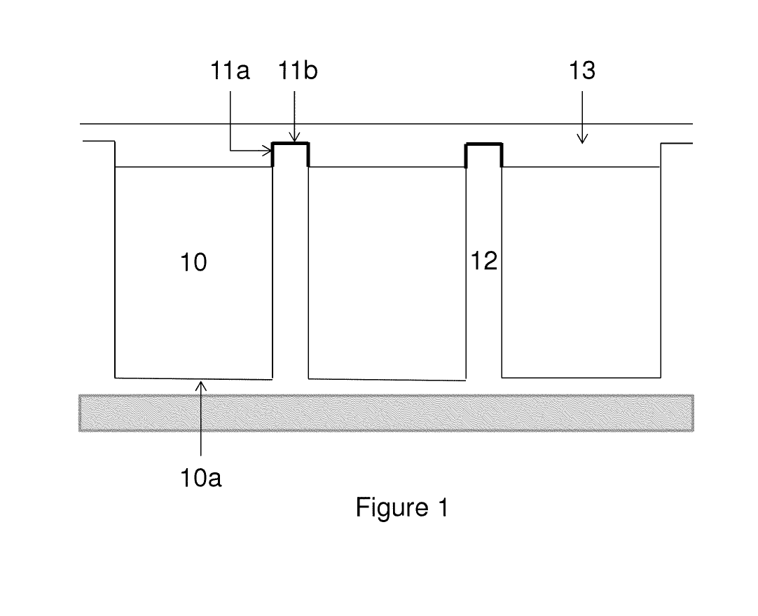

The microcell structure referred to includes the partition walls (12) separating the microcells (10) and bottom (10a) of the microcells if present, as shown in FIG. 1. The covalent bonding may be formed at the interface (e.g., 11a and 11b) between the sealing layer (13) and the microcell structure.

The microcells may be formed from a microembossing process using an embossable composition, for example, a UV curable embossable composition. The UV curable embossable composition usually comprises a component, such as monofunctional acrylate, monofunctional methacrylate, multifunctional acrylate, multifunctional methacrylate or the like, which has functional groups (e.g., vinyl group, mercapto group or the like). During the curing process, some of the functional groups remain unreacted and the unreacted functional groups are then available for crosslinking when a suitable sealing composition is used.

The functional groups available for crosslinking may also be from a material additionally added to a composition for forming the microcell structure, and these functional groups, such as hydroxyl group, amino group, carboxyl group or the like, can survive the UV curing process.

Alternatively, functional groups may be added to the fully or partially cured microcap structure. For example, a plasma process may be applied to post-treat the surface of the microcell structure and in the process, functional groups such as —COOH, —NH₂, —OH or the like, may be generated on the surface of the microcell structure.

The unreacted functional groups in the microcell structure may be utilized to form strong covalent bonding with a sealing layer when an appropriate sealing composition is chosen.

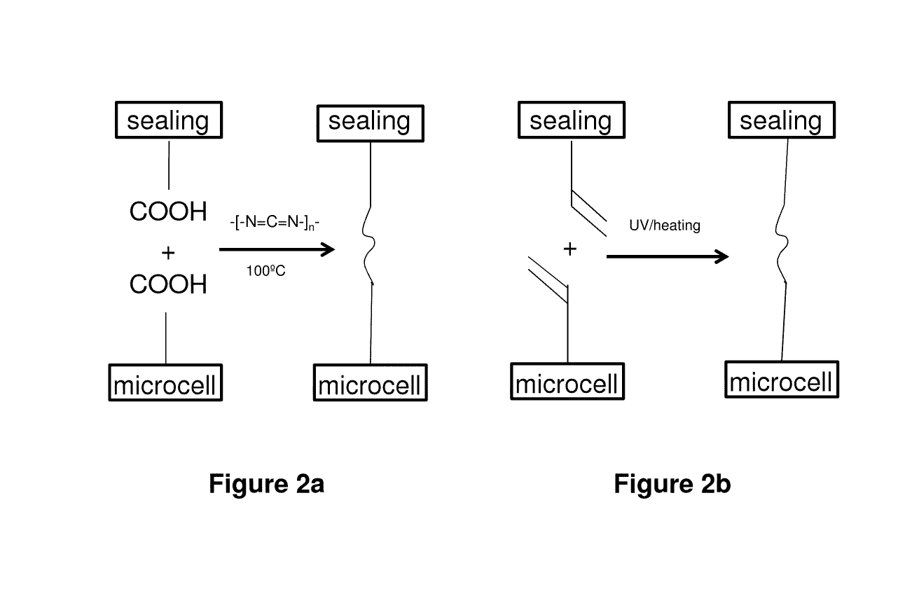

FIGS. 2a and 2b are abbreviated drawings to illustrate the present invention. FIG. 2a shows that the surface of the microcell structure has unreacted —COOH functional groups and a sealing composition comprising a component with —COOH functional groups and a crosslinker, such as polycarbodiimide, is used. In this case, covalent bonds are formed between the sealing layer and the surface of the microcell structure, upon heating. Any of the commonly known crosslinkers, such as multifunctional epoxies or aldehydes may be used instead of polycarbodiimide.

FIG. 2b shows that the surface of the microcell structure has unreacted vinyl groups and a sealing composition comprising also vinyl functional groups is used. In this case, with the aid of heating or UV radiation, strong covalent bonds are formed between the sealing layer and the surface of the microcell structure. In radical polymerization between the sealing composition and the microcell structure, a photo- or thermal initiator may be optionally added to facilitate the formation of the covalent bonding.

Suitable thermal initiators may include, but are not limited to, 2,2′-azobis(2-methylpropionitrile), benzoyl peroxide, potassium persulfate and 4,4′-azobis(4-cyanovaleric acid).

Suitable photoinitiators may include, but are not limited to, bis-acyl-phosphine oxide, 2-benzyl-2-(dimethylamino)-1-[4-(4-morpholinyl)phenyl]-1-butanone, 2,4,6-trimethylbenzoyl diphenyl phosphine oxide, 2-isopropyl-9H-thioxanthen-9-one, 4-benzoyl-4′-methyldiphenylsulphide, 1-hydroxy-cyclohexyl-phenyl-ketone, 2-hydroxy-2-methyl-1-phenyl-propan-1-one, 1-[4-(2-hydroxyethoxy)-phenyl]-2-hydroxy-2-methyl-1-propane-1-one, 2,2-dimethoxy-1,2-diphenylethan-1-one and 2-methyl-1[4-(methylthio)phenyl]-2-morpholinopropan-1-one.

Sealing components which comprise functional groups that can be crosslinked with the microcell surface may include, but are not limited to, monofunctional acrylates, monofunctional methacrylates, multifunctional acrylates, multifunctional methacrylates, polyvinyl alcohol, polyacrylic acid, cellulose, gelatin or the like.

If a heating process is used to generate the covalent bonding, the preferred functional group pairs between the sealing layer and the microcell structure may include carboxylic acid group/carboxylic acid group, carboxylic acid group/amino group, carboxylic acid group/hydroxyl group and carboxylic acid group/expoxy group.

If a UV curing process is used to generate the covalent bonding, the preferred functional group pairs between the sealing layer and the microcell structure may include vinyl group/vinyl group and vinyl group/mercapto group.

The sealing layer as described may be formed by the one-pass or two-pass method. A display fluid is filled and sealed within the microcells.

In one embodiment of the present invention, the display fluid filled in the microcells may be a liquid crystal composition or an electrophoretic fluid.

An electrophoretic fluid typically comprises charged pigment particles dispersed in a solvent or solvent mixture. The fluid sandwiched between two electrode plates may have one, two or more types of charged pigment particles. When there are two or more types of charged pigment particles dispersed in the solvent or solvent mixture, the charged pigment particles may have optical characteristics differing from one another.

In addition to the colors, the different optical characteristics may include optical transmission, reflectance, luminescence or, in the case of displays intended for machine reading, pseudo-color in the sense of a change in reflectance of electromagnetic wavelengths outside the visible range.

According to the present invention, a microcell-based electrophoretic display device has a strong adhesion between the sealing layer and partition walls in the microcell structure which can prevent defects and significantly improve reliability of the device.

### EXAMPLES

Preparation 1: Preparation of Sealing Composition without Crosslinker (Comparative)

15 Grams of carboxylic acid functionalized polyurethane dispersion (L-2857, Hauthaway, USA) and 60 g of 20 wt % polyvinyl alcohol (Mowiol 40-88, Kuraray, Japan) aqueous solution were stirred thoroughly for 1 hour and debubbled by a centrifuge at 2000 rpm for about 30 minutes.

Preparation 2: Preparation of Sealing Composition with Crosslinker 15 Grams of carboxylic acid functionalized polyurethane dispersion (L-2857, Hauthaway, USA), 60 g of 20 wt % polyvinyl alcohol (Mowiol 40-88, Kuraray, Japan) aqueous solution and 3.4 g of 50 wt % polycarbodiimide (XL701, Picassian, USA) aqueous solution were stirred thoroughly for 1 hour and debubbled by a centrifuge at 2000 rpm for about 30 minutes.

### Example 1

### Preparation of Display Films

A microcell structure was formed on an ITO/PET substrate by a microembossing process using the microcell composition as described in U.S. Pat. No. 6,930,818. After microembossing, the microcell structure was surface treated with vacuum plasma to generate carboxylic acid groups, and then filled with an electrophoretic fluid, followed by coating of a sealing composition of Preparation 1 or 2, respectively, and dried at 100° C. for 5 minutes to form display films.

### Example 2

### Tensile Peeling Test

The display films in Example 1 were cut into stripes with a width of 2.5 cm and a length of 10 cm. The sealing layer was peeled off from the display films by Instron at a 180 degree angle and 50 mm/min.

For the display film prepared from the sealing composition of Preparation 1, a clear separation was observed between the sealing layer and the microcell structure, indicating the adhesion between the sealing layer and microcell surface was weaker than the adhesion between the microcell surface and ITO/PET substrate.

For the display film prepared from the sealing composition of Preparation 2, a clear separation was observed between the microcell array and ITO/PET substrate, indicating the adhesion between the sealing layer and microcell surface was stronger than the adhesion between the microcell surface and ITO/PET substrate.

While the present invention has been described with reference to the specific embodiments thereof, it should be understood by those skilled in the art that various changes may be made and equivalents may be substituted without departing from the scope of the invention. In addition, many modifications may be made to adapt a particular situation, materials, compositions, processes, process step or steps, to the objective, spirit and scope of the present invention. All such modifications are intended to be within the scope of the claims appended hereto.

It is therefore wished that this invention to be defined by the scope of the appended claims as broadly as the prior art will permit, and in view of the specification if need be.

What is claimed is:

1. A display device comprising:
a) a microcell structure with microcells filled with a display fluid; and
b) a sealing layer enclosing the display fluid within each of the microcells,
wherein there is covalent bonding between the sealing layer and the microcell structure.

2. The device of claim 1, wherein the covalent bonding is formed from crosslinking between functional groups from a composition for forming the sealing layer and functional groups from a composition for forming the microcell structure.

3. The device of claim 2, wherein the functional groups from the composition for forming the microcell structure are unreacted during curing of the microcell structure.

4. The device of claim 1, wherein the covalent bonding is formed from crosslinking between functional groups from a composition for forming the sealing layer and functional groups from a material additionally added to a composition for forming the microcell structure.

5. The device of claim 4, wherein the functional groups are hydroxyl, amino, or carboxyl.

6. The device of claim 1, wherein the covalent bonding is between functional groups of the sealing layer and functional groups of the microcell structure generated from post treatment of surface of the microcell structure.

7. The device of claim 6, wherein the functional groups of the microcell structure are COOH, —NH₂ or —OH.

8. The device of claim 1, wherein functional group pairs between the sealing layer and the microcell structure are carboxylic acid group/carboxylic acid group, carboxylic acid group/amino group, carboxylic acid group/hydroxyl group or carboxylic acid group/expoxy group.

9. The device of claim 1, wherein functional group pairs between the sealing layer and the microcell structure are vinyl group/vinyl group or vinyl group/mercapto group.

10. The device of claim 1, wherein the display fluid is an electrophoretic fluid.
